(19) United States
(12) Patent Application Publication
(10) Pub. No.: US 2014/0173070 A1
(43) Pub. Date: Jun. 19, 2014

(54) UPDATING OF DIGITAL CONTENT BUFFERING ORDER

(71) Applicant: MICROSOFT CORPORATION, Redmond, WA (US)

(72) Inventors: Frank R. Morrison, III, Seattle, WA (US); Alexander Burba, Seattle, WA (US); Brandon Hunt, Redmond, WA (US)

(73) Assignee: MICROSOFT CORPORATION, Redmond, WA (US)

(21) Appl. No.: 13/713,957

(22) Filed: Dec. 13, 2012

(51) Int. Cl. H04L 29/06

(52) U.S. Cl. CPC H04L 65/40
USPC 709/223

(57) ABSTRACT

Embodiments for dynamically varying a buffering order of a digital content item are disclosed. One disclosed embodiment provides a computing device configured to receive content access information for a plurality of client devices, the content access information describing consumption of a digital content item provided according to a buffering order previously sent to each client device of the plurality of client devices. The computing device is further to dynamically update the buffering order based on the content access information to produce an updated buffering order and to send the updated buffering order to one or more client devices.

### BACKGROUND

A digital content item, such as a video game, may comprise a large amount of data, and therefore may take a potentially significant amount of time to download in full. To help prevent long waiting times, some digital content items may allow a user to interact with the content before downloading is complete. However, a user interacting with the content may experience delays during play as the user reaches portions of the content that have not yet been downloaded.

### SUMMARY

Embodiments are disclosed that relate to dynamically updating an order of the buffering of portions of a digital content item. For example, one disclosed embodiment provides a computing device including a logic subsystem and a storage subsystem, the storage subsystem comprising instructions stored thereon that are executable by the logic subsystem to receive content access information for a plurality of client devices, the content access information describing consumption of a digital content item provided according to a buffering order previously sent to each client device of the plurality of client devices. The instructions are further executable to dynamically update the buffering order based on the content access information to produce an updated buffering order, and to send the updated buffering order to one or more client devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an example embodiment of a digital content consumption environment.

FIG. 2 schematically illustrates an embodiment of a method for providing a digital content item.

FIG. 3 illustrates a flow diagram depicting an embodiment of a method for dynamically adjusting a buffering order of a digital content item.

FIG. 4 illustrates an example embodiment of a computing system.

### DETAILED DESCRIPTION

As mentioned above, downloadable digital content items, may allow a user to begin interacting with the content before downloading is complete. However, a user interacting with the content may experience interruptions (e.g. page faults) during play as the user reaches portions of the content that have not yet been downloaded.

Digital content items may be obtained according to a “buffering order” that defines an order in which the content portion(s) of a digital content item are to be acquired by a presentation system. As a digital content item may comprise a plurality of different user experiences (e.g., different game play modes, various possible paths through a large game, non-linear media accesses, etc.), different users may consume a particular content item differently, and thus may also experience different interruptions as a content item is consumed during acquisition. For example, in the case of a video game, some users may play the game slowly and methodically while trying to solve all challenges in a level before progressing to a next level, whereas others may skip optional challenges and instead progress to higher levels as soon as possible. Therefore, different interruptions may arise depending upon if and/or when different users reach content portion(s) of the digital content item that not yet acquired.

As such, embodiments are disclosed herein that relate to the dynamically adjusting a buffering order provided for a digital content item to potentially reduce the likelihood of such interruptions. For example, the buffering order may be refined by tracking how digital content items are consumed. In other words, as a digital content item is accessed by a plurality of users, temporal information regarding how each user accesses portions of the digital content item may be tracked. Then, a buffering order provided for the digital content item may be adjusted to help reduce the likelihood of interruptions during consumption of the content item. It will be understood that the terms “content portion” and the like denote any portion of data of the digital content item, and may or may not correspond to a discrete feature, file, object, etc. of the digital content item. For example, in some embodiments, a “content portion” may correspond to a memory location of a content portion, such as a range of memory offsets relative to a beginning of the content item.

In some embodiments, descriptive metadata may exist for content and/or portions thereof. In such embodiments, the metadata may help to provide an understanding of the nature of the content portions being accessed. Thus, such metadata may be used to provide a higher understanding of the gameplay style of a user and/or other digital content consumption characteristics of the user, and therefore may offer additional information for determining buffering orders for that user.

Interruptions may arise from factors other than an order in which a user accesses content portions. For example, the delivery of content portions to provide an above-threshold experience (e.g., full-quality, substantially uninterrupted, above threshold level of tolerated interruptions, etc.) may depend upon the rate of user access as well as an ability to supply the content portions to the client devices. This may rely on factors such as network bandwidth, device performance, and the like. Thus, embodiments are disclosed that additionally take into account such network and/or device performance characteristics when determining and/or adjusting a buffering order.

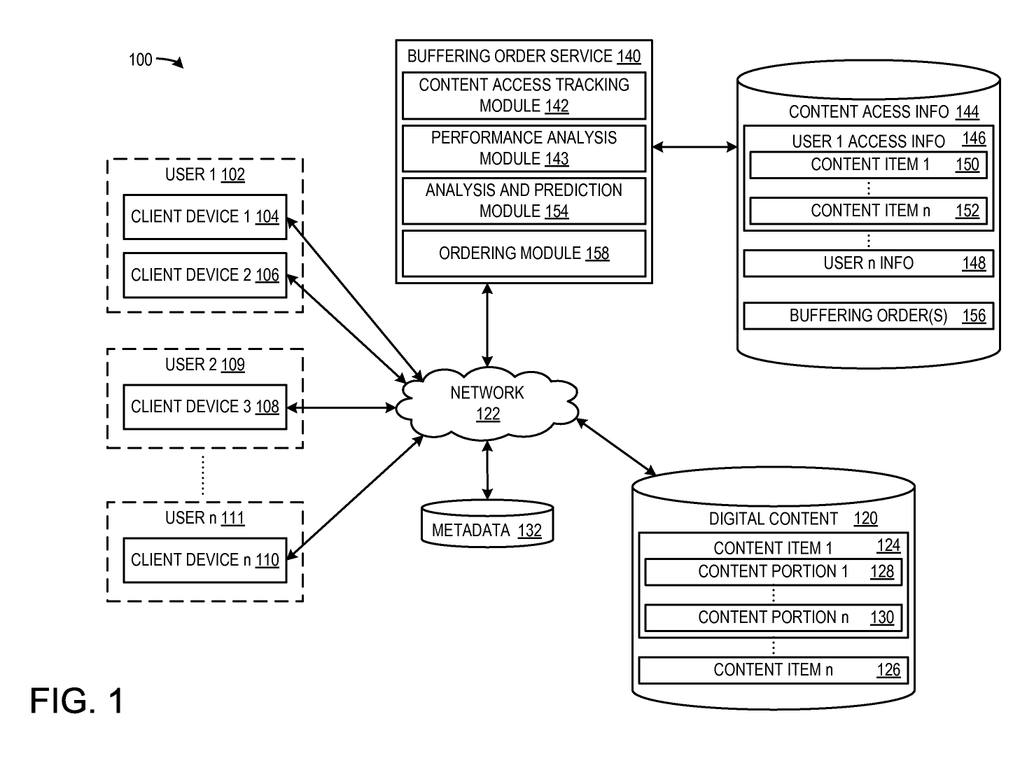

Prior to discussing these embodiments in more detail, an example embodiment of a use environment 100 is described with reference to FIG. 1. Use environment 100 comprises a plurality of client devices each configured to receive and present digital content items, wherein each client device may be associated with a corresponding user. Further, in some instances, more than one client device may be associated with a user and/or more than one user may be associated with a client device (e.g., via individual user profiles, etc.). For example, a user may have two or more of a video game console, a mobile device, a computer (laptop, desktop, tablet), a wearable device (e.g. head-mounted display), etc., and may consume digital content items via each of such devices. Such a scenario is illustrated as first user 102 being associated with both first client device 104 (e.g. video game console) and second client device 106 (e.g. mobile device, wearable device, portable device, computer, etc.). In order to illustrate the multi-user nature of use environment 100, FIG. 1 further comprises two other client devices associated with other users in the form of third client device 108 associated with user 2 and client device n 110 associated with user n 111.

Each of client devices 104, 106, 108 and 110 is in communication with one or more digital content stores 120 (e.g. locations from which content may be acquired) via network 122 (e.g. computer network, cellular phone network, and/or any other suitable type of network). Digital content store 120 is depicted as storing a plurality of digital content items, illustrated as digital content item 1 124 and digital content item n 126. While described in the context of a client-server environment, it will be understood that other embodiments may utilize any other suitable architecture, including, but not limited to, a peer-to-peer configuration. It will be appreciated that the embodiment of FIG. 1 is provided for the purpose of example, and is not intended to be limiting in any manner.

Each digital content item comprises a plurality of content portions, examples of which are shown as content portion 1 128 and content portion n 130 for digital content item 1 124. Digital content items 124, 126 may represent any suitable type of digital content, including, but not limited to, interactive content such as video games, interactive video, and social media. Other examples include, but are not limited to, movies, television shows and other videos, music, photographs, websites, etc. Likewise, content portions 128, 130 may take any suitable form. For example, content portions 128, 130 may take the form of specific portions of memory (e.g. memory locations, disk sectors, etc.), or, by extension, specific files, etc.

As mentioned above, in some embodiments one or more digital content items and or portions of a digital content item may have associated descriptive metadata that describes an identity, characteristic, and/or other property of the content portion. For example, in the case of a video game, metadata 132 may comprise information regarding an identity of one or more virtual objects (e.g. character/object identification, location/setting, etc.) represented (partially or fully) by a content portion. Metadata 132 also may comprise information regarding the digital content item as a whole (e.g. genre), and/or any other suitable information. Such metadata is illustrated in FIG. 1 as being stored in a metadata store 132 that is located remotely from the digital content store 120. However, it will be understood that metadata 132 may be stored in any suitable location, including with the corresponding content item in some embodiments.

As mentioned above, temporal information regarding how user(s) accessed a particular digital content item may be used to refine buffering orders for that content item and/or for other content items. Accordingly, environment 100 further comprises a buffering order service 140. The buffering order service 140 comprises a content access tracking module 142 configured to receive and track content access information for one or more digital content items. The content access information may include, for example, information describing an order in which various content portions were accessed, times at which different content portions were accessed, and/or other information describing user interaction with the digital content item(s).

Further, in some embodiments, buffering order service 140 may further include or otherwise be in communication with a performance analysis module 143 configured to obtain (e.g., via measurement and/or calculation) data related to the performance of the client devices (e.g., processor load, etc.), the performance of digital content store 120 (e.g., simultaneous users, storage subsystem bandwidth, etc.), the performance of any one or more interconnecting mechanisms (e.g., bandwidth of network 122), and/or any other suitable information regarding network and/or device-related factors that may impact consumption of the digital content item.

Content access information store 144 may store content access information for a plurality of users, illustrated as user 1 information 146 and user n information 148. The user-specific information may comprise access information for each digital content item accessed by each user. For example, as illustrated, user 1 access information 146 includes content item 1 access information 150 and content item n access information 152. The content-specific access information may comprise any suitable information, including, but not limited to, an order in which content portions of each digital content item were accessed by that user, and/or other such temporal information. Although illustrated as being stored on a user-by-user basis, it will be appreciated that the content access information may be stored accordingly to any suitable mechanism, granularity, etc. without departing from the scope of the present disclosure.

Content access information may be obtained by the buffering order service 140 from the client devices as users of the client devices consume digital content items via the devices. In some embodiments, the content access information may be obtained by the buffering order service so as not to interfere with acquisition (e.g., via digital content store 120) of the digital content item by the client devices, such as by providing the content access information during detected periods of inactivity, predicted periods of inactivity, etc. Further, in some embodiments, the buffering order service may be included with a digital provision service (e.g., digital content store 120), and thus may monitor content access patterns as content is downloaded from the digital provision service.

Buffering order service 140 further comprises an analysis and prediction module 154 configured to analyze the content access information and to predict future consumption behaviors of digital content items (e.g. likely game experiences that a user may consume in near future) based on such analysis. By analyzing various content access information, buffering order service 140 may be able to determine a likelihood of interruption to future consumption of a digital content item, and refine an order by which content portion(s) of the digital content item are provided to the client devices. This may help to decrease a likelihood of interruption during consumption. Analysis and prediction module 154 may be configured to analyze any suitable content access information to provide such predictions, such as, for example, content access information for a single digital content item, for a family of titles, for a selected genre, for multiple titles of different genres, and/or for any one or more digital content items. Further, in some embodiments, metadata 132 may be utilized so as to better understand the content access information, as mentioned above.

Information provided by the analysis and prediction module 154 and the performance analysis module 143 may be used by a buffer ordering module 158 to determine and/or refine buffering order(s) for one or more digital content items to provide one or more above-threshold experiences. As mentioned above, an order and rate at which a user accesses portions of a digital content item may depend upon how the user consume the digital content item (e.g., how much time taken to navigate through a particular level of a video game), and also upon the rate at which the content portions can be delivered to the client (e.g., due to network bandwidth considerations, etc.).

Accordingly, ordering module 158 may be configured to utilize the information from the analysis and prediction module 154 and performance analysis module 143 in order to determine buffering order(s) that may potentially decrease a likelihood of interruptions to the user experience. In some embodiments, a buffering order may be determined that is usable to provide an above-threshold experience over a prospective access window, wherein the prospective access window may correspond to a time period of game play, a set of one or more predefined experiences of a content item, or any other suitable definition. For example, in some embodiments, a buffering order may be determined that is usable to provide an above-threshold experience for a selected set of levels of a video game. As another example, a buffering order may be determined that is usable to provide an above-threshold experience for a selected time period, independent of number of levels accessed. As yet another example, the buffering order service may define a buffering order comprising a set of content portions usable to begin and/or maintain an above-threshold experience of the digital content item. These scenarios are presented for the purpose of example, and are not intended to be limiting in any manner.

As illustrated, the buffering order(s) determined by the buffering order service may be stored as buffering orders 156 for future use and/or refinement. It will be understood that such information may stored in any suitable location. For example, buffering orders may be stored locally by the client devices in other embodiments.

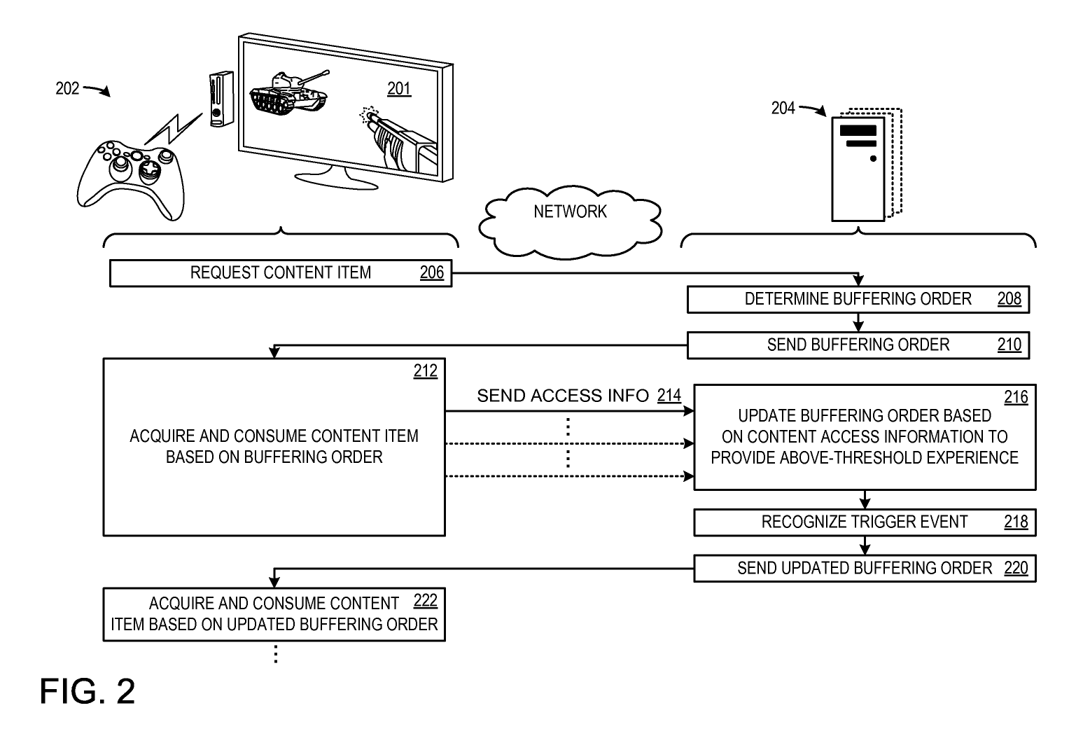

Turning now to FIG. 2, an example use scenario for providing a digital content item 201 (e.g., first-person combat video game) is illustrated, wherein FIG. 2 illustrates communication between client device 202 and buffering order service 204 (e.g., buffering order service 140). While FIG. 2 illustrates a client-server relationship, it will be appreciated that digital content items may be provided via any suitable mechanism (e.g., peer-to-peer connection(s)) or combination of mechanisms without departing from the scope of the present disclosure.

In order to begin experiencing the digital content item, client device 202 requests the digital content item, as illustrated at 206. Such a request may be effected manually and/or programmatically in various scenarios. As one non-limiting example, computing device 202 may request content item 201 upon user request, or may be configured to programmatically acquire the digital content item based on previous user access of related content (e.g. an earlier version of the content, similar genres, titles, developers, etc.).

In response to the request, the buffering order service may determine a buffering order at 208. As previously mentioned, the buffering order may be determined based on previously-obtained content access information, where the access information may include information obtained for the same user, different users, the same content item, and/or different content items. In some scenarios (e.g., initial play scenarios), the buffering order may correspond to a pre-defined order provided by a developer, publisher, etc. Regardless of how the buffering order is determined or otherwise obtained, the buffering order is sent to the client device.

At 212, the client device may acquire and consume the digital content item based on the buffering order received from the service. The digital content item may be acquired from any suitable source or sources, including, but not limited to, network-accessible content stores.

The client device may be configured to monitor and send, and/or the service may be configured to request, content access information describing how the digital content item is accessed by the client device. The content access information may be sent from the client device at periodic and/or non-period intervals (e.g., every 5 minutes, every day at midnight, during periods of low activity, etc.), as illustrated at 214. As a more specific example, the content access information may be provided to the buffering order service upon detecting inactivity at the client device (e.g., during the middle of the night), so as to reduce network bandwidth used at any particular time, for example. In other embodiments, the client device may be configured to programmatically provide the content access information, whereas the service may be configured to request the content access information in other embodiments.

As content access information is received from the client device, the service may refine the buffering order based on such information, as illustrated at 216. In other words, the buffering order may be updated so as to decrease a likelihood of interruption to future consumption (i.e., consumption according to the updated buffering order) of the digital content item. As a more specific example, some content access requests made by the client during consumption (e.g. requests made out of order compared to the buffering order provided to the client) may correspond to requests for content portions due to page faults. As such, a buffering order may be updated to reduce an incidence of such requests. Further, one or more performance metrics may be usable to refine the buffering order. The buffering order may be updated based upon any suitable criteria. For example, the buffer may be refined to provide a certain time period of substantially uninterrupted access (e.g., 30 minutes) for a particular experience, to provide one or more predefined user experiences (e.g., levels, sports matches, etc.) without substantial interruption, etc.

As described above, a nature of user interaction with an interactive digital content item may vary from user to user, and thus the buffering order may be refined in light of such uncertainty. For example, in some embodiments, the buffering order may be refined to include provision of multiple potential access patterns (e.g., buffer both level 3 and level 4 if user is currently on level 2) in order to potentially mitigate interruptions effected by unpredictable content interactions. It will be appreciated that such scenarios are presented for the purpose of example, and are not intended to be limiting in any manner.

As digital content items are acquired according to the buffering order presently stored by the client device, it will be appreciated that digital content item(s) may be accessed according the stored buffering profile until a new buffering order is received. However, it will be further appreciated that it may be undesirable to update the buffering profile frequently, as frequent updating may reduce, and even potentially negate, the potential performance benefits provided by refining the buffering order (e.g., due to overhead in retrieving new buffering orders, content portions, etc.). Thus, such factors may be taken into account when determining whether to update a buffering order.

Thus, as illustrated at 218, the buffering service may be configured to recognize a “trigger event” configured to trigger an update of the buffering order at 220. Any suitable event may be defined to trigger updating of a buffering order. For example, a triggering event may correspond to a system state where the current buffering order is determined to be insufficient for maintaining an above-threshold experience. For example, a user that typically rushes through levels without completing ancillary tasks in the levels may be provided with the digital content item according to a buffering order that moves at least some of such ancillary tasks to a later location in the buffering order. However, if the user's actual content consumption patterns during game play indicate that the user may be more likely to interact with ancillary content in a level, a buffering order provided to the user may be updated to avoid interruptions to the user experience. As another example, the digital content item may be provided according to a buffering order configured for high network bandwidth. Accordingly, upon detecting a trigger event of low available network bandwidth, a new buffering order may be provided that is configured for lower-bandwidth conditions. It will be appreciated that the above-mentioned triggering events are presented for the purpose of example, and that trigger events may include user-specific events, content item-specific events, and/or any other suitable events. Further, while described in the context of a remote service detecting a triggering event, it will be understood that triggering events also may be detected via a client device.

Upon receiving the updated buffering order, client device 202 may acquire and consume the digital content item according to the updated buffering order, as illustrated at 222. It will be understood that although a single updated buffering order is illustrated as being supplied to the client device, further updates may be provided as a user continues to interact with the content item. Further, while FIG. 2 shows a single buffering order sent at each of steps 210 and 220, it will be understood that multiple buffering orders may be sent at one or more of these steps, and the client device receiving the multiple buffering orders may determine which of the buffering orders to use as consumption of the digital content item progresses.

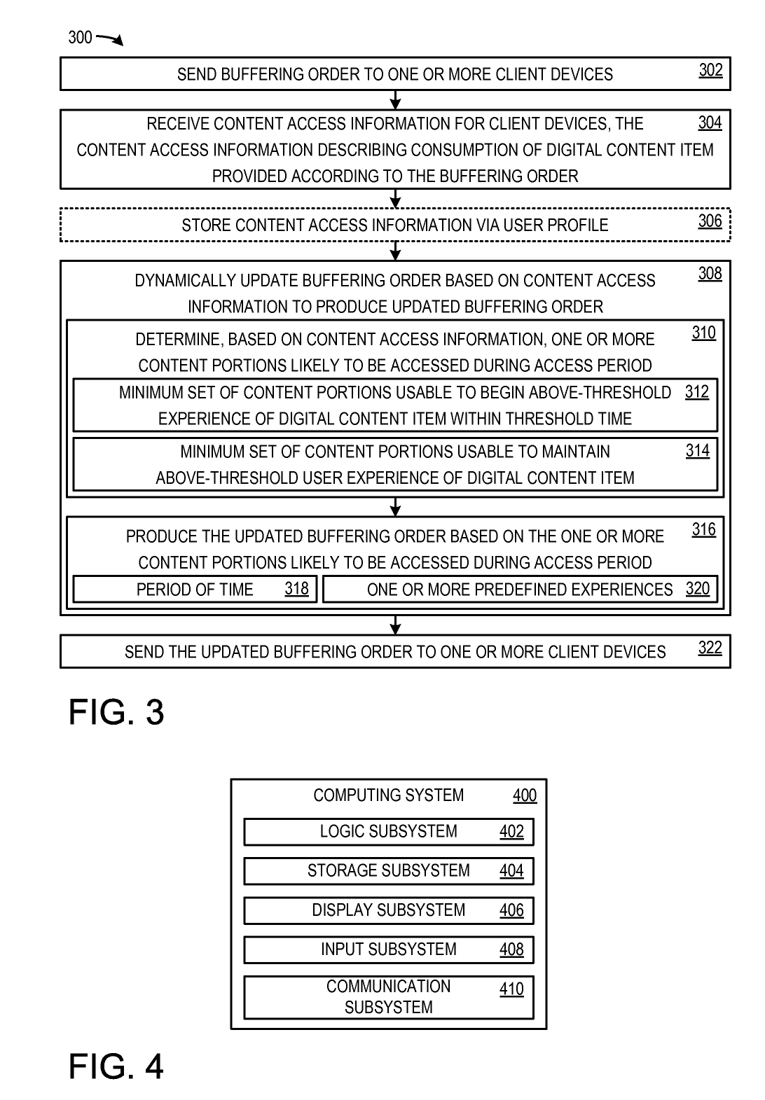

FIG. 3 shows an embodiment of a method 300 for dynamically adjusting a provision of a digital content item. At 302, method 300 may comprise sending a buffering order to one or more client devices (e.g., client devices 104, 202, etc.). The buffering order may correspond to a default initial buffering order, an initial buffering order related to a particular experience selected by a user from a plurality of possible experiences, an initial buffering order selected based upon information in a user's profile, and/or any other suitable order. Further, in some embodiments, the initial buffering order may be obtained from a different source.

Method 300 further comprises, at 304, receiving content access information for a plurality of client devices, wherein the content access information comprises information regarding consumption of a digital content item provided according to the buffering order. In other words, while the digital content item is being acquired according to the buffering order, information describing such consumption (e.g., what content portion(s) are consumed, rate of consumption, network metrics, and/or any other suitable information) is received.

In some embodiments, method 300 may further comprise storing the content access information via a user profile at 306. Such a profile may be included with, for example, a “roaming” profile usable across a plurality of computing devices and/or digital content items. The roaming profile may not be limited to a content access profile, and in some embodiments may further include game play achievements, user profile information, and/or any other suitable information. Although consolidation of user-specific content access information via user profiles may enable increased user-specific refinement of buffering orders, it will be appreciated that such a configuration is presented for the purpose of example and is not intended to be limiting in any manner.

By continuously acquiring such content access information across a plurality of users, devices and/or content items, a buffering order may be modified to provide a greater amount of uninterrupted access (e.g., reduce page faults, etc.) more efficiently, for example.

Thus, method 300 further comprises dynamically updating the buffering order based on the content access information to produce an updated buffering order at 308. In some embodiments, dynamically updating 308 the buffering order may comprise, at 310, determining, based on the content access information, one or more content portions likely to be accessed during a prospective access window. As one non-limiting example, the determined content portions may include a set of content portions usable to maintain the above-threshold user experience, as shown at 314. Likewise, updating the buffering order may include recognizing a current user experience (e.g., current level of a video game), and updating the buffering order based on the current user experience.

As mentioned above, an above-threshold experience may be defined as any suitable experience relative to any suitable threshold. For example, in addition to a threshold defined as a selected frequency of page faults, a threshold experience also may be related to a lag time before commencing playback, in which case the term “above-threshold” indicates a start time faster than a threshold time. Thus, as another non-limiting example, the determined portions may include a set of content portions usable to begin an above-threshold experience within a threshold amount of time, as shown at 312.

Continuing with FIG. 3, dynamically updating 308 the buffering order may further comprise, at 316, producing the updated buffering order based on the one or more content portions likely to be accessed during a prospective access window. The prospective access window corresponds to a target amount (e.g., amount of time, amount of predefined user experiences, amount of content portions, etc.) of an above-threshold user experience. The prospective access window may be defined in any suitable manner to support any suitable use scenario. For example, as described above, the prospective access window may be defined in terms of time 318, such as a desired time of substantially uninterrupted consumption. In other embodiments, the prospective access window may be defined in terms of one or more predefined experiences 320 (e.g., levels, sports matches, individual task, etc.) during which substantially uninterrupted consumption is desired. It will be appreciated that these scenarios are presented for the purpose of example, and the prospective access window may be determined according to various granularities and via various mechanisms without departing from the scope of the present disclosure.

At 322, the method further comprises sending the updated buffering order to one or more client devices. It will be understood from the previous description that the buffering order may be supplied to client devices for which content access information was not previously received. In this way, as buffering order(s) are updated over time in order to account for observed variations in content access, users accessing a particular content item for the first time may be able to leverage the updated buffering order, thereby potentially providing a more satisfactory experience.

In some embodiments, the methods and processes described above may be tied to a computing system of one or more computing devices. In particular, such methods and processes may be implemented as a computer-application program or service, an application-programming interface (API), a library, and/or other computer-program product.

FIG. 4 schematically shows a non-limiting embodiment of a computing system 400 that can enact one or more of the methods and processes described above. Computing system 400 is shown in simplified form. Client devices 104 and 202, a server system used to run service 204, digital content store 120 and a server system used to run buffering order service 140 are non-limiting examples of computing system 400. It will be understood that any suitable computer architecture may be used without departing from the scope of this disclosure. In different embodiments, computing system 400 may take the form of a mainframe computer, server computer, desktop computer, laptop computer, tablet computer, home-entertainment computer, network computing device, gaming device, mobile computing device, mobile communication device (e.g., smart phone), etc.

Computing system 400 includes a logic subsystem 402 and a storage subsystem 404. Computing system 400 may optionally include a display subsystem 406, input subsystem 408, communication subsystem 410, and/or other components not shown in FIG. 4.

Logic subsystem 402 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Storage subsystem 404 includes one or more physical, non-transitory, devices configured to hold data and/or instructions executable by the logic subsystem to implement the methods and processes described herein. When such methods and processes are implemented, the state of storage subsystem 404 may be transformed—e.g., to hold different data.

Storage subsystem 404 may include removable media and/or built-in devices. Storage subsystem 404 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 404 may include volatile, nonvolatile, dynamic, static, read/write, read-only, random-access, sequential-access, location-addressable, file-addressable, and/or content-addressable devices.

It will be appreciated that storage subsystem 404 includes one or more physical devices. However, in some embodiments, aspects of the instructions described herein may be propagated via a transmission medium by a pure signal (e.g., an electromagnetic signal, an optical signal, etc.) that is not held by a physical storage device. Furthermore, data and/or other forms of information pertaining to the present disclosure may be propagated by a pure signal.

In some embodiments, aspects of logic subsystem 402 and of storage subsystem 404 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

The terms “module” and/or “program” may be used to describe an aspect of computing system 400 implemented to perform a particular function. In some cases, a module and/or program may be instantiated via logic subsystem 402 executing instructions held by storage subsystem 404. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and/or program may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 406 may be used to present a visual representation of data held by storage subsystem 404. This visual representation may take the form of a graphical user interface (GUI). As the herein described methods and processes change the data held by the storage subsystem, and thus transform the state of the storage subsystem, the state of display subsystem 406 may likewise be transformed to visually represent changes in the underlying data. Display subsystem 406 may include one or more display devices utilizing virtually any type of technology. Such display devices may be combined with logic subsystem 402 and/or storage subsystem 404 in a shared enclosure, or such display devices may be peripheral display devices.

When included, input subsystem 408 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 410 may be configured to communicatively couple computing system 400 with one or more other computing devices. Communication subsystem 410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a logic subsystem; and
a storage subsystem comprising instructions stored thereon that are executable by the logic subsystem to:
receive content access information for a plurality of client devices, the content access information describing consumption of a digital content item provided according to a buffering order previously sent to each client device of the plurality of client devices;
dynamically update the buffering order based on the content access information to produce an updated buffering order; and
send the updated buffering order to one or more client devices.

2. The computing device of claim 1, wherein the content access information is received from a first client device, and wherein the updated buffering order is sent to the first client device.

3. The computing device of claim 2, wherein the instructions are further executable to store the content access information for a user of the first client device via a user profile.

4. The computing device of claim 1, wherein the instructions to dynamically update the buffering order include instructions executable to
determine, based on the content access information, one or more content portions likely to be accessed during a prospective access window, and
produce the updated buffering order based on the one or more content portions likely to be accessed during the prospective access window.

5. The computing device of claim 4, wherein the prospective access window comprises one or more of a period of time and a predefined experience of the digital content item.

6. The computing device of claim 1, further comprising sending multiple buffering orders to the client to allow the client to select a buffering order based upon current digital content consumption progress.

7. The computing device of claim 4, wherein determining the one or more content portions likely to be accessed during the prospective access window comprises determining a set of content portions for maintaining an above-threshold user experience of the digital content item.

8. The computing device of claim 4, wherein determining the one or more content portions likely to be accessed during the prospective access window comprises determining a set of content portions usable to begin an above-threshold experience of the digital content item.

9. The computing device of claim 1, wherein the instructions executable to dynamically update the buffering order include instructions executable to
determine, based on the content access information, a likelihood of interruption to future consumption of the digital content item provided according to the buffering order, and
update the buffering order so as to reduce the likelihood of interruption to consumption of the digital content item by the one or more client device.

10. The computing device of claim 1, further comprising utilizing descriptive metadata related to the content access information to dynamically update the buffering order.

11. A method for dynamically adjusting provision of a digital content item, the method comprising:
obtaining content access information describing consumption of the digital content item by a client, the digital content item being provided according to a buffering order previously sent to the client;
determining, based on the content access information, a likelihood of interruption to future consumption of the digital content item provided according to the buffering order;
updating the buffering order to produce an updated buffering order, the updated buffering order being configured to decrease the likelihood of interruption to future consumption of the digital content item by the client; and
providing the updated buffering order to the client.

12. The method of claim 11, wherein dynamically updating the buffering order comprises:
determining, based on the content access information, one or more content portions likely to be accessed during an prospective access window; and
producing the updated buffering order based on the one or more content portions likely to be accessed during the prospective access window.

13. The method of claim 12, wherein the prospective access window includes a period of time.

14. The method of claim 12, wherein the prospective access window includes one or more experiences of the digital content item.

15. The method of claim 12, wherein the one or more content portions likely to be accessed during the prospective access window comprises a determined set of content portions usable to maintain an above-threshold user experience of the digital content item.

16. The method of claim 11, wherein the digital content item comprises a video game.

17. A method for dynamically adjusting provision of a digital content item, the method comprising:
receive content access information for a plurality of client devices, the content access information describing consumption of a digital content item comprising a plurality of content portions;
determining a buffering order configured to provide a determined set of content portions usable at any particular time to maintain an above-threshold user experience of the digital content item; and
sending the buffering order to one or more client devices.

18. The method of claim 17, further comprising recognizing a current user experience of the digital content item, where the buffering order is further determined based on the current user experience.

19. The method of claim 18, where the set of content portions comprises the content portions usable to provide the current user experience.

20. The method of claim 17, further comprising maintaining a user profile for each user of the one of the client devices based on the content access information, where the set of content portions comprises the content portions usable to provide the digital content item over a period of time, where the set provided to each client device is determined based on the user profile for the user of the client device.
